(19) United States
(12) Patent Application Publication
(10) Pub. No.: US 2024/0137636 A1
(43) Pub. Date: Apr. 25, 2024

(54) Optoelectronic sensor for detecting objects in a detection zone and method of highlighting the location of a detection zone

(71) Applicant: SICK AG, Waldkirch (DE)

(72) Inventors: Jürgen REICHENBACH, Waldkirch (DE); Andreas BEHRENS, Waldkirch (DE)

(21) Appl. No.: 18/380,328

(22) Filed: Oct. 15, 2023

(30) Foreign Application Priority Data
Oct. 20, 2022 (EP) 22203117.1

(51) Int. Cl. H04N 23/56; G06K 7/14; H04N 23/74

(52) U.S. Cl. CPC H04N 23/56; G06K 7/1404; H04N 23/74

(57) ABSTRACT

An optoelectronic sensor for detecting objects in a detection zone is provided that comprises a light reception element for generating a received signal from light that is incident on the light reception element from the detection zone, a display device for highlighting the location of the detection zone for the human eye by a light pattern projected into the detection zone, and a control and evaluation unit for evaluating the received signal, In this respect, the light pattern has at least two partial patterns that are projected from different sources and that together mark a center of the detection zone independently of a distance into which the light pattern is projected into the detection zone.

The invention relates to an optoelectronic sensor for detecting objects in a detection zone and to a method of highlighting the location of a detection zone respectively.

It is useful in a large number of applications to make the detection zone of an optoelectronic sensor visually perceptible. An example among many is the reading field of a code reader. On a manual reading, the code to be read can thus be moved into the correct position. The installation phase is supported in a reading tunnel that conveys objects through the reading field. A display device for visualizing the detection zone is also called an aiming device because the alignment of the sensor can be tracked by it. A single laser dot that marks the center can be sufficient to highlight the detection zone, but more complex patterns are also used. In actual operation, for example during the image recording of a camera, the aiming device is typically switched off to avoid interference.

The environment of the optical axis of the sensor is required for the light reception, for example for an objective and a camera chip. Light sources of the aiming device can therefore only be attached off axis. However, this has the consequence that the visualization of the detection zone can only be set to a certain distance, for example to the focal distance. A lateral offset of the light dot or light pattern arises at distances differing therefrom.

EP 2 136 248 A1 discloses an image recording device with adaptable illumination, namely object illumination and/or positioning illumination. An adjustment of the focusing of the reception optics automatically effects the adaptation of the object illumination and/or positioning illumination to the adjusted focus. This is thus an example of an aiming device that is set to the focal distance since a superposition of the projected light patterns results exactly there.

WO 2009/007772 A2 deals with a camera system that projects a luminous reference figure onto the detection plane, with the focusing of the camera and of the reference figure corresponding to one another. The focal distance is consequently also selected here; the reference Figure can anyway not provide any optimum visualization at other distances.

The still unpublished European patent application 22185480.5 describes a code reading device having a focus adjustment and feedback on the quality of the currently set focal position. This can take place via a light signal or a light pattern that a display device projects onto the optical code. This is a further example for the commitment to the focal distance.

It is therefore the object of the invention to further improve a display device of an optoelectronic sensor for visualizing the detection zone.

This object is satisfied by an optoelectronic sensor for detecting objects in a detection zone and by a method of highlighting the location of a detection zone in accordance with the respective independent claim. Detecting an object can here mean, for example, determining a property of the object such as its distance, recording an image of the object or of a scene with the object, reading an optical code, and the like. Light from the detection zone is incident on a light reception element and is converted into a received signal, in particular to generate image data. A display device makes the detection zone visible to the human eye by means of a projected light pattern. The display device is preferably configured as an aiming device to align the optoelectronic sensor. The alignment can be checked and readjusted by the visual feedback. A control and evaluation unit evaluates the received signal or the image data. It can take place internally in the optoelectronic sensor, externally in a processing unit connected thereto such as a controller, a computer, a network, or a cloud, and partly internally and externally. The specific evaluation and its aim can be very diverse; this is not initially of importance since the invention relates to the optical highlighting of the location of the detection zone.

The invention starts from the basic idea of assembling the light pattern from at least two partial projected patterns. A respective partial pattern is produced from a separate source; it is not a question of calling partial regions of a light pattern projected in common a partial pattern. The partial patterns can be generated directly by the source, for example a line generator, or a pattern generation element is arranged downstream per source or partial pattern that can be configured simply as a cylindrical lens or a slit diaphragm, but also in a more complex manner as a DOE (diffractive optical element). The two partial patterns together mark a center of the detection zone. Marking here means the visual highlighting or making visible to the human eye. The two partial patterns mark the center independently of a distance at which the projected light pattern in the detection zone is incident on the scene, an object, or the background.

A source may be a light source such as an LED or a laser or may be derived therefrom, for example by splitter mirrors. The sources cannot be arranged coaxially because the optical axis, as mentioned in the introduction, is already occupied by the reception path. The optical axis is here the one of the optoelectronic sensor of the light reception element or of a reception optics associated therewith. Despite the inevitable axial offset of the sources from the optical axis of the optoelectronic sensor, the invention succeeds in marking the center of the detection zone independently of the distance and not, for example, only at a focal distance.

The invention has the advantage that the center of the projected light pattern coincides with the optical axis independently of the distance and thus allows a conclusion to be drawn on the location of the detection zone with the same accuracy and the same reliability independently of the distance. Corresponding sources for generating partial patterns such as DOE pattern projectors or laser line projectors are available at low cost in small design sizes. In this respect, different colors or wavelength ranges are also possible to further improve the visualization or to visually recognizably clearly delineate the light pattern in different scenes. The setup of the sensor is at most negligibly more complex due to the display device in accordance with the invention than with the known solutions described in the introduction. A modular setup is possible in which the display device can be simply inserted into an existing sensor concept or into its illumination.

The respective partial pattern is preferably a line, with the lines being at an angle to one another, in particular perpendicular to one another, and intersecting at the center. Two lines that are perpendicular to one another form something similar to a cross. Unlike a projected cross, however, the point of intersection is not fixed and is offset with respect to a middle of the lines depending on the distance at which the partial patterns are projected. The center of the detection zone thus remains marked independently of the distance, which would not be the case with a projected cross that has an offset from the center in dependence on the distance. The principle by which the point of intersection of the lines highlights the center independently of the distance is the same with two lines at an angle that is not perpendicular or with more lines, for example three lines at an angular offset of 120°. The lines in this embodiment are the carrying element of the respective partial pattern; the center is thereby marked. However, this does not preclude partial patterns or light patterns from still comprising additional elements, for example a dot pattern, to communicate a better surface impression or additional pattern elements, for whatever reason, that would not be required for the marking of the center.

The sources are preferably arranged at an angular offset from one another about the center in a peripheral direction, at an angle different from 0° and 180°. In this embodiment, the sources are thus not on a common radius and are also not on a common diameter through the center. In the case of lines as partial patterns, for example, only a common line would otherwise result overall as a light pattern from the two partial patterns without any recognizable point of intersection at the center. Examples for angular offsets not equal to 0° and 180° are sources arranged offset by 90° from one another. In this respect, the sources do not necessarily have to be on the same circle around the center different radial distances are conceivable.

A respective partial pattern preferably marks its own partial pattern center and the center is thus marked as the middle of the partial pattern centers. An additional or also a single visual indication of the center can be provided by this embodiment. It is easily possible for the human eye to recognize the partial pattern centers and then also their middle as the sought center of the detection zone. In this respect, the center in the light pattern can already be highlighted; the partial pattern centers then provide an additional indication. Alternatively, the center is not marked in the light pattern itself and is located by the observer using the middle of the partial pattern centers.

The respective partial pattern is preferably a cross or an arrangement of concentric circles. They are examples of partial patterns that mark their own partial pattern centers. The case of a cross as a partial pattern may not be confused with conventional aiming devices. The point of intersection there marks the center, but with there being an offset from the actual center with an off axis arrangement of the source. In the embodiment explained here, in contrast, the point of intersection marks the partial pattern center and the center of the detection zone is the middle of the partial pattern centers only in the second step. The center is thus highlighted without offset at every distance.

The partial patterns are preferably identical with one another. In this respect, identical can in particular be understood as congruent and of the same size. This simplifies the setup of the sensor and the recognition of the center. For example, two crosses are projected; the middle is then at the middle of the points of intersection or two arrangements of concentric circles are projected, with the center at the middle of the connection of the center points of the circle.

The sources are preferably arranged at both sides of the center at an equal distance from the center. In this embodiment, the sources are not, as above, arranged at an angular offset not equal to 0° and 180°, but, differing therefrom, are arranged on a common diameter so-to-say to the right and left of the optical axis or of the reception path. This is in particular suitable in conjunction with partial patterns that mark their own partial pattern centers.

The sources preferably each have a display light source. Each partial pattern is thus produced from its own light source such as an LED or a laser diode, with the light source, for example, being able to have a plurality of individual light sources for higher luminous intensities.

At least one source preferably decouples light of a different source by means of a beam splitter. In this embodiment, every source no longer has its own light source. At least two sources share a common light source. There can be further optical elements in addition to the beam splitter; for example further mirrors to move the partial patterns to a desired position and/or into a desired orientation.

The sensor preferably has an illumination device to illuminate the detection zone, with the display device being part of the illumination device. The illumination device supports the actual detection of the sensor. The illumination device frequently operates in a non-visible wavelength range, in particular in the infrared range or is always only active for a brief period. The illumination device is thus not suitable to visually highlight the detection zone, particularly since it also does not specify any pattern that would simplify the determination of the location of the detection zone for the human eye. The display device, in particular its display light sources, can, however, be integrated in the illumination device. A common illumination/display module can in particular be formed.

The illumination device preferably has a plurality of light sources distributed over a periphery, in particular distributed in a circular manner, with sources of the display device being arranged between the light sources distributed over the periphery. The light sources distributed over the periphery, preferably with the optical axis of the sensor at the center point, provide that the detection zone is illuminated in accordance with the optical axis. The sources of the display device can be scattered into this periphery. This is, on the one hand, a suitable position for projecting the partial patterns and simplifies the overall setup, on the other hand. Alternative arrangements of the light sources of the illumination device are conceivable, for example forming a matrix with the sources at matrix positions or therebetween.

The sensor is preferably configured as a camera with the light reception element being configured as an image sensor having a plurality of pixel elements to generate image data. The received signal in this case is a respective recorded image or a detail therefrom. The pixel elements are preferably arranged to form a matrix.

The sensor is preferably configured as a code reading device for reading optical codes, with the control and evaluation unit being configured to read an optical code by evaluating the received signal using a decoding process. The code reading device can be a barcode scanner or a camera based code reader.

The sensor is preferably installed in a stationary manner at a conveying device that leads objects to be detected in a conveying direction through the detection zone. This is a particularly frequent application situation, in particular with sensors configured as code readers in a reading tunnel. The alignment of the sensor in its stationary operating positions is simplified and improved by the marking of the center of the detection zone in accordance with the invention.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

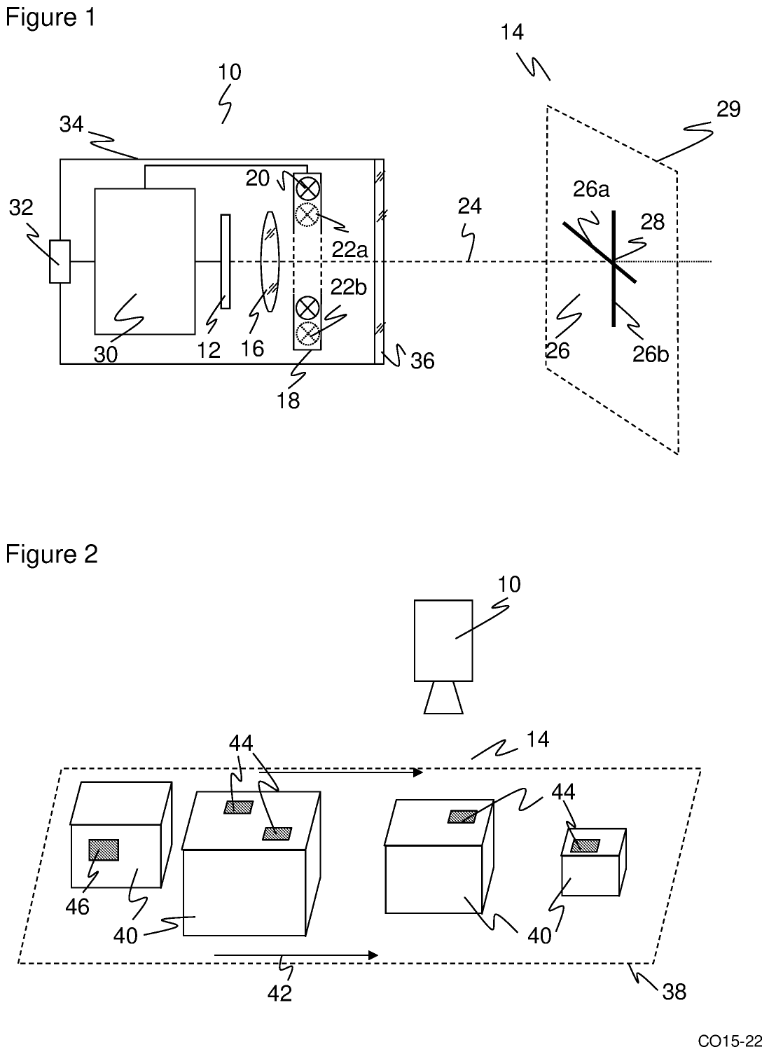

FIG. 1 a schematic sectional representation of an optoelectronic sensor;

FIG. 2 an exemplary installation of an optoelectronic sensor configured as a camera at a conveying device;

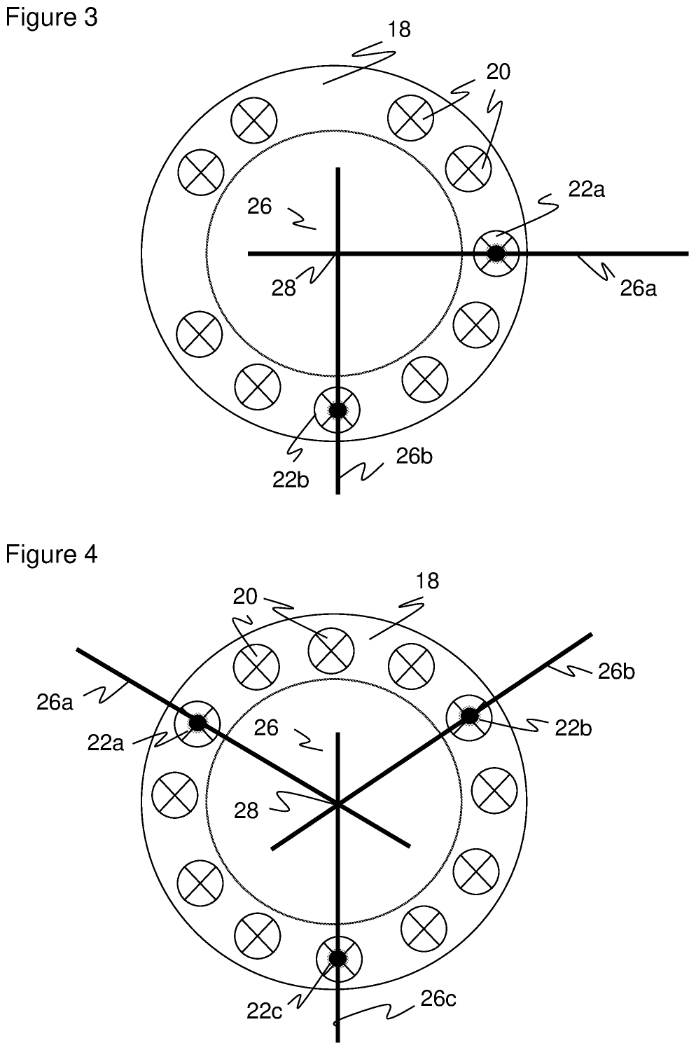

FIG. 3 a plan view of an illumination device with a circular arrangement of light sources and two line projectors inserted there;

FIG. 4 a view similar to FIG. 3, now with three line projectors;

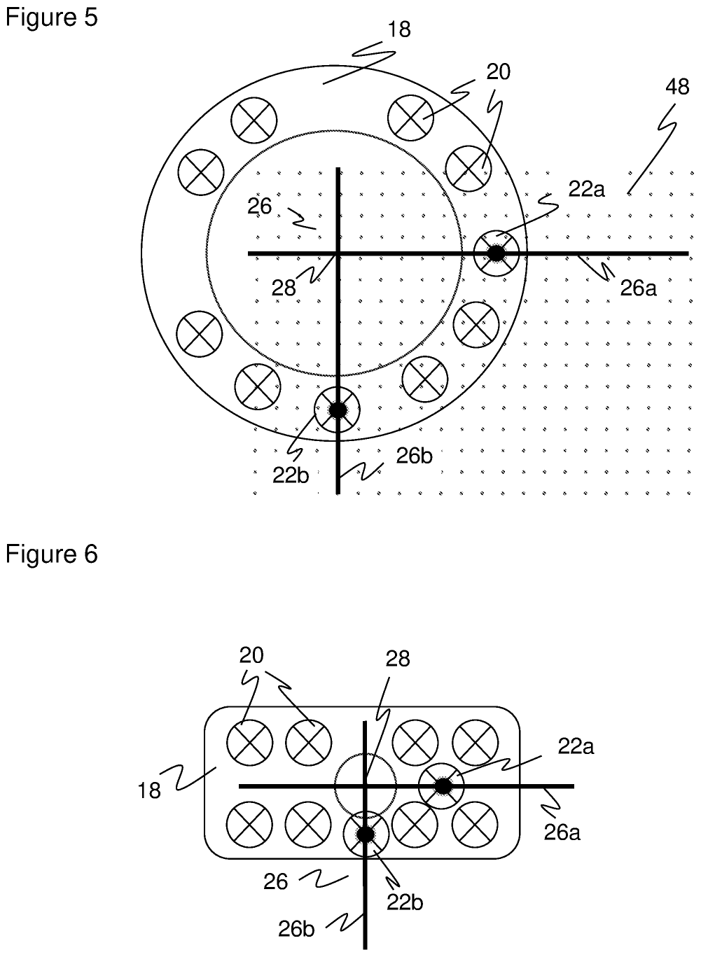

FIG. 5 the view of FIG. 3 with an additional dot pattern;

FIG. 6 a plan view of an illumination device with a matrix-like arrangement of light sources and two line projectors inserted there;

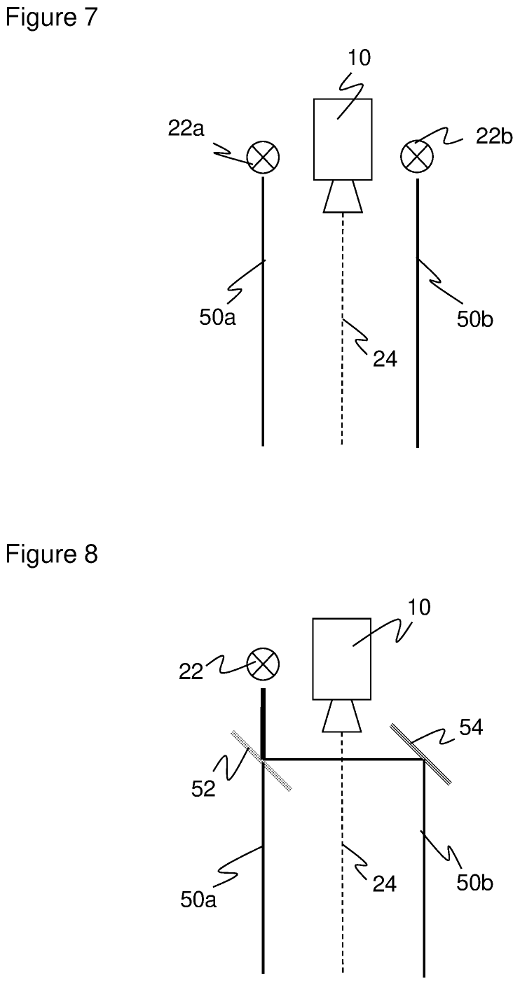

FIG. 7 a schematic view of an optoelectronic sensor configured as a camera with two lateral axially parallel projectors;

FIG. 8 a view similar to FIG. 7 with only one projector and an additional decoupling by means of splitter mirrors;

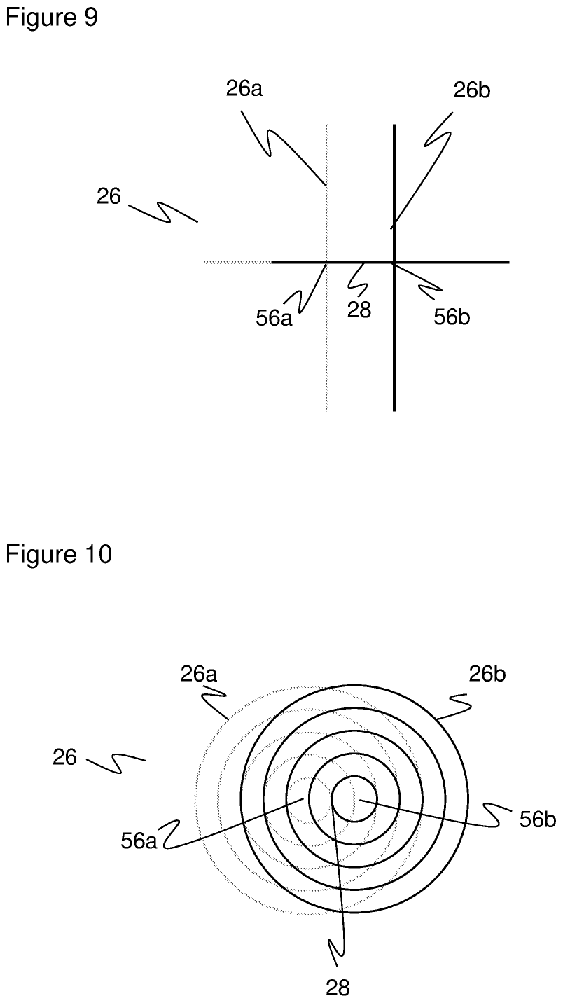

FIG. 9 two crosses as exemplary partial patterns; and

FIG. 10 two arrangements of concentric circles as exemplary partial patterns.

FIG. 1 shows a schematic sectional representation of an optoelectronic sensor that is here configured by way of example as a camera, in particular as a camera based code reader. A light reception element 12, in particular an image sensor having pixel elements arranged to form a matrix, generates a received signal or image data from incident light from a detection zone. A reception optics 16 is arranged upstream of the light reception element 12 and is preferably designed as an objective of a plurality of lenses and other optical elements such as diaphragms, prisms, and the like, but here only represented by a lens for reasons of simplicity.

The sensor 10 comprises an illumination unit 18 having a plurality of light sources 20 to illuminate the detection zone 14. In addition, two display light sources 22a-b, shown by dashed lines, are provided in the illumination unit 18. Alternatively, the display light sources 22a-b can be independent of the illumination unit 18. The light sources 20 and display layer sources 22a-b can be LEDs or laser diodes, for example. The geometrical arrangement of the light sources 20 and of the display light sources 22a-b can only be seen insufficiently from the purely schematic representation of FIG. 1. They are, for example, arranged in a circular manner about the optical axis 24 of the sensor 10. These and further arrangements will be shown and discussed below.

The display light sources 22a-b together generate a light pattern 26 in the detection zone 14, possibly with the aid of a respective pattern generation element, not shown. The light pattern 26 comprises at least two partial patterns 26a-b, with each partial pattern 26a-b being projected from a respective one display light source 22a-b. The two partial patterns 26a-b mark the center 28 of the detection zone 14. This is now a substantially two-dimensional observation in a plane 29 of the detection zone 14 at a given distance. The light pattern 26 is formed in this plane 29 because an object or a background such as a wall or a conveyor belt is located here.

A coaxial arrangement of a display light source 22a-b on the optical axis 24 is not possible because the reception path of the light reception element 12 or of the reception optics 16 would thereby be shaded. Although the display light sources 22a-b are thus arranged off axis, i.e. with an offset from the optical axis 24, the center 28 is marked independently of the distance at which the plane 29 is located. In the example shown in FIG. 1, both partial patterns 26a-b are respectively a line of different orientations, in particular perpendicular to one another, such that the lines intersect one another and mark the center 28 with their point of intersection. The cross of the two lines is asymmetrically distorted depending on the distance of the plane 29, but the point of intersection remains at the center 28. The position of the detection zone 14 is thus trackable at all distances for a human observer using the center 28, for example to position an object centrally in the detection zone 14 or to check or adjust an installation position and an alignment of the sensor 10.

A control and evaluation unit 30 that has at least one digital processing module is connected to the light reception element 12 and to the illumination unit 18, and is responsible for the control work, evaluation work, and other coordination work in the sensor 10. It generates the light pattern 26 as required, illuminates the detection zone 14, records the received signal or images, and evaluates the received signal or the image data. In an embodiment as a code reader, detected optical codes are read with the received signal or by the image data. For this purpose, a segmentation preferably takes place in a manner known per se to locate code regions and the code regions are supplied to at least one decoder. Read codes, optionally also raw data or pre-processing results, can be stored or can be output at an interface 32. A plurality of modules can be provided for the different control and evaluation work, for example to perform pre-processing of the image data on a separate FPGA and to carry out the actual evaluation by means of a microprocessor. At least some parts of the control and evaluation unit can also be provided externally.

The interface 32 or a further interface can be used to activate and deactivate the display light sources 22a-b from external. Differing from FIG. 1, the illumination unit 18 and/or a unit having the display light sources 22a-b, can be an external part having corresponding connectors for activating the illumination or the light pattern 26. However, a separate control of the display light sources 22a-b can also be dispensed with, for example in that the display light sources 22a-b are automatically deactivated when the illumination is active in order not to disrupt the actual detection in operation.

The sensor 10 is protected by a housing 34 that is terminated by a front screen 36 in the front region where light 12 enters and departs. The constructive setup shown is to be understood purely by way of example.

FIG. 2 shows an exemplary installation of an optoelectronic sensor 10 configured as a camera at a conveying device, for example, a conveyor belt 38. The sensor 10 is shown here only as a symbol and no longer with its setup explained with reference to FIG. 1. The conveyor belt 38 conveys objects 40, as indicated by the arrow 42, through the detection region 14. The objects 40 bear code regions 44 in an application example at their outer surfaces. It is the object of the sensor 10 in the application example to recognize code regions 44, to decode the codes affixed there, and to associate them with the respective associated object 40. In order also to detect laterally applied code regions 46, additional sensors 10, not shown, are preferably used from different perspectives. In addition, a plurality of sensors 10 can be arranged next to one another to together cover a wider detection zone 14. FIG. 2 is an application example; the invention is not limited to an installation position at a conveyor belt 38 nor is the function of the sensor 10 restricted to code reading. For example, different object properties can be detected such as object geometries and object sizes, different quality features, and indeed also in application situations in which the respective object moves into the detection zone 14 in a different manner than by means of a conveyor belt 38, in particular by a manual presentation.

FIG. 3 shows a plan view of the illumination device 18 in an exemplary circular or annular arrangement of the light sources 20 and of the two display light sources 22a-b that are inserted there and that are configured as line projectors here. The direction of observation here is along the optical axis 24 so that some geometrical ratios complementary to FIG. 1 can be recognized better. The two display light sources 22a-b each generate a line extending radially to the optical axis 24 as a partial pattern 26a-b of the light pattern 26 and the center 28 of the detection zone 14 is marked as the point of intersection of the lines. In a camera as the optoelectronic sensor 10, with a typical central arrangement of the light reception element then formed as an image sensor, the center 28 is then at the image middle.

The center 28 is marked independently of the distance here. If the light pattern 26 is incident on a nearer or more remote object, the horizontal line of the partial patterns 26a is displaced or extended or shortened in its horizontal line direction and the vertical line of the partial pattern 26b is displaced or extended or shortened in its vertical line direction. However, this does not alter anything about the position of the point of intersection at the center 28.

FIG. 4 shows a view similar to FIG. 3, now with three display light sources 28a-c or line projectors and correspondingly three lines as a partial light pattern 26a-c. It should, on the one hand, be illustrated by this that a distance independent marking of the center 28 having more than two partial patterns 26a-c and/or having lines not perpendicular to one another is possible. On the other hand, a light pattern 26 is produced in this manner that is rotationally symmetrical to the optical axis 24 overall and that can have advantages in interaction with the light sources 20 of the illumination unit 18 and with respect to visibility.

FIG. 5 shows the view of FIG. 3 with an additional dot pattern 48 to further illustrate possible embodiments. The principle in accordance with the invention of marking the center 28 by partial light patterns 26a-b independently of the distance allows additional pattern elements such as the dot pattern 48 shown purely by way of example. Such pattern elements can support the visualization of the position of the detection zone 14, but can also serve very different purposes, for example superposing sensor information.

FIG. 6 shows a plan view of an illumination device 18, now with a rectangular or matrix-like arrangement of light sources 20 and two display light sources 22a-b inserted at matrix positions or between matrix positions there, here again in the form of line projectors. The distance independent marking of the center 28 by partial patterns 26a-b does not depend on the design of the illumination device 18 and can be combined with the most varied illumination devices 18.

Figure, 7 shows a schematic view of an optoelectronic sensor 10 configured as a camera with two lateral display light sources 22a-b. The respective projection direction 50a-b is in parallel with the optical axis 24 so that axially parallel projectors are formed. Alternatively, an inclination toward the optical axis 24 would also be conceivable. In such an embodiment with display light sources 22a-b symmetrical to both sides of the optical axis 24, somewhat more complex partial patterns 26a-b are preferably used that will be presently discussed with reference to FIGS. 9 and 10. For this purpose, pattern generation elements, not shown, are arranged downstream of the display light sources 22a-b, for example a respective DOE (diffractive optical element), with such pattern generation elements also being able to be used in the previous embodiments, in particular to generate lines.

Before the discussion of further suitable partial patterns 26a-b, FIG. 8 still shows a view similar to FIG. 7 as an alternative with only one display light source 22. Whereas up to now the sources from which the projection of a respective partial pattern 26a-b starts respectively utilized their own display light source 22a-b, a source is now instead produced by decoupling by means of a splitter mirror or a beam splitter 52. The display light source 22 is thereby effectively doubled to two sources. If a pattern generation element is used, the decoupling preferably takes place behind it so that not only light is decoupled, or even light modulated or shaped in accordance with the partial pattern 26a-b. Two partial patterns 26a-b are thereby produced from the same physical projector. The light path after the decoupled source can be realigned once or multiple times by further optical elements, as by way of example in FIG. 8 by means of a mirror 54. In principle, further decoupling would be conceivable to provide additional sources. And even though the generation of additional sources has been explained in connection with a symmetrical axially parallel arrangement, it is also conceivable for the embodiments explained above with reference to FIGS. 3 to 6. Wherever a plurality of display light sources 22a-b are described in this description, at least one display light source 22a-b can be replaced with a decoupling.

FIG. 9 shows an example for partial patterns 26a-b that are in particular suitable to mark the center 28 in connection with the axially parallel projectors of FIGS. 7 and 8. The partial patterns 26a-b are here already crosses per se so that the respective partial pattern center 56a-b is immediately recognized. However, due to the off axis offset of the associated display light sources 22a-b the partial pattern enters 56a-b by no means coincide with the center 28 independently of the distance. The center 28 is rather marked in that it is disposed at the middle between the two partial pattern centers 56a-b. This middle and thus the center 28 are likewise immediately recognizable for the human eye and the location of the middle is distance independent.

FIG. 10 shows an alternative example for partial patterns 26a-b, now with arrangements of concentric circles instead of crosses. The partial pattern centers 56a-b are immediately recognizable as a center point of the circles and thus likewise the middle of the partial pattern centers 56a-b and consequently the center 28.

1. An optoelectronic sensor for detecting objects in a detection zone that has a light reception element for generating a received signal from light that is incident on the light reception element from the detection zone, a display device for highlighting the location of the detection zone for the human eye by a light pattern projected into the detection zone, and a control and evaluation unit for evaluating the received signal,
wherein the light pattern has at least two partial patterns that are projected from different sources and that together mark a center of the detection zone independently of a distance into which the light pattern is projected into the detection zone.

2. The sensor in accordance with claim 1,
wherein the respective partial pattern is a line, the lines being at an angle to one another and intersecting at the center.

3. The sensor in accordance with claim 2,
wherein the lines are perpendicular to one another.

4. The sensor in accordance with claim 1,
wherein the sources are arranged about the center at an angular offset from one another in a peripheral direction at an angle different from 0° and 180°.

5. The sensor in accordance with claim 1,
wherein a respective partial pattern marks its own partial pattern center and the center is thus marked as the middle of the partial pattern centers.

6. The sensor in accordance with claim 5,
wherein the respective partial pattern is a cross or an arrangement of concentric circles.

7. The sensor in accordance with claim 5
wherein the partial patterns are identical with one another.

8. The sensor in accordance with claim 5,
wherein the sources are arranged at both sides of the center at the same distance from the center.

9. The sensor in accordance with claim 1,
wherein the sources each have a display light source.

10. The sensor in accordance with claim 1,
wherein at least one source decouples light of a different source by means of a beam splitter.

11. The sensor in accordance with claim 1
that has an illumination device for illuminating the detection zone and
wherein the display device is part of the illumination device.

12. The sensor in accordance with claim 11,
wherein the illumination device has a plurality of light sources distributed over a periphery; and wherein sources of the display device are arranged between the light sources distributed over the periphery.

13. The sensor in accordance with claim 12,
wherein the plurality of light sources are distributed in a circular manner.

14. The sensor in accordance with claim 1
that is configured as a camera, wherein the light reception element is configured as an image sensor having a plurality of pixel elements to generate image data.

15. The sensor in accordance with claim 1
that is configured as a code reading device for reading optical codes,
wherein the control and evaluation unit is configured to read an optical code by evaluating the received signal using a decoding process.

16. The sensor in accordance with claim 1
that is installed in a stationary manner at a conveying device that guides objects to be detected in a conveying direction through the detection zone.

17. A method of highlighting the location of a detection zone of an optoelectronic sensor in which a light pattern visible to the human eye is projected into the detection zone, and wherein at least two partial patterns are projected from at least two different sources and that together mark a center of the detection zone independently of a distance into which the light pattern is projected into the detection zone.

18. The method of claim 17, wherein the optoelectronic sensor has a light reception element for generating a received signal from light that is incident on the light reception element from the detection zone, a display device for highlighting the location of the detection zone for the human eye by a light pattern projected into the detection zone, and a control and evaluation unit for evaluating the received signal.
